(19) United States
(12) Patent Application Publication
(10) Pub. No.: US 2013/0118682 A1
(43) Pub. Date: May 16, 2013

(54) SUBSTRATE WITH CARBON NANOTUBES, AND METHOD TO TRANSFER CARBON NANOTUBES

(71) Applicant: Heinrich Zeininger, Obermichelbach (DE)

(72) Inventor: Heinrich Zeininger, Obermichelbach (DE)

(21) Appl. No.: 13/713,467

(22) Filed: Dec. 13, 2012

Related U.S. Application Data
(62) Division of application No. 13/075,401, filed on Mar. 30, 2011, now abandoned.

(30) Foreign Application Priority Data
Mar. 30, 2010 (DE) 102010013359.0

(51) Int. Cl. H01J 9/02

(52) U.S. Cl. CPC H01J 9/025
USPC 156/249

(57) ABSTRACT

A substrate for field emitters uses carbon nanotubes (CNTs) on a conductive substrate, the CNTs being erected essentially perpendicular to the substrate and aligned. In a method to transfer a CNT forest from a first substrate to a second substrate, the second substrate is coated with adhesive and the peaks (tips) of the CNTs on the first substrate are embedded in the uncurred adhesive on the second substrate. After the adhesive cures, the CNTs are removed from the first substrate with the peaks anchored in the cured adhesive on the second substrate.

### RELATED APPLICATION

The present application is a divisional of Ser. No. 13/075,401, filed Mar. 30, 2011.

### BACKGROUND OF THE INVENTION

1. Field of the Invention

The invention concerns a substrate with carbon nanotubes, (CNTs) and methods to transfer carbon nanotubes from one substrate to another.

2. Description of the Prior Art

Electron field emitters can be constructed with the use of carbon nanotubes. Arranged in a vacuum vessel with anode, novel x-ray tubes can be realized in this manner.

Disadvantages of the conventional techniques for manufacturing substrates with carbon nanotubes are the low currents and the low mechanical stability of the field emitters.

### SUMMARY OF THE INVENTION

An object of the present invention is to achieve CNTs on a substrate that enable higher currents and long-term durability of field electron emitters for use in computer tomography.

It is general knowledge that CNTs are ideal field emitters because they are as conductive as metals and have a diameter of a few nanometers; therefore they are extremely small.

The above object is achieved in accordance with the invention by a substrate for a field electron emitter suitable for use in computer tomography, wherein the substrate is electrically conductive and carbon nanotubes are aligned and arranged upright on the substrate. In addition, the invention encompasses the use of such a substrate in field emitters, and in particular in computed tomography.

Most coatings of CNT resting on the substrate are produced from solution. The specific properties of CNTs—such as the low diameter and the tube morphology—are not used due to the arrangement of CNTs that is thereby generated. Given the use of CNT tubes for electron emitters, in particular as many tube ends as possible should be present in the direction of the anode in order to use the lower electron work function at the tube ends.

According to the invention, as many nanotubes as possible are therefore arranged so that the tube ends are present in the direction of the anode. In principle a higher reactivity exists at the ends of the tubes than at the tube wall. Oxidations thus preferably occur at the tube openings. The electron work function is lower at the tube openings than at the tube walls.

Chemical vapor deposition (CVD) is advantageously used to produce the aligned CNTs. A particularly high density of aligned CNTs can be achieved with this method.

The aligned CNTs can be produced with floating catalyst methods or in a quartz reactor, for example with a 17 nm-thick aluminum buffer layer between the iron catalyst (3 nm) and the silicon wafer. Aligned CNTs grow on different substrates, steel, silicon and additional metals or metal alloys or other conductive materials.

The interposed metallic layer is converted into a particular surface structure during the production process. The arising particles catalyze the CNT growth. The tube diameter of the multi-wall nanotubes is approximately 10 nm. The number of tubes is between 3 to 10 multi-walls. The aligned, grown tubes are also designated as CNT forests on the basis of their appearance.

### BRIEF DESCRIPTION OF THE DRAWINGS

FIG. 1 at the left side shows deposition of a carbon nanotube in the tip growth mode, and at the right side shows deposition of a carbon nanotube in the base growth mode.

FIGS. 2a, 2b, 2c schematically illustrate a carbon nanotube transfer procedure in accordance with the present invention.

### DESCRIPTION OF THE PREFERRED EMBODIMENTS

For example, the aligned CNTs are produced as follows:

a)

The oven is heated to a deposition temperature of approximately 775° C. To grow the aligned CNTs, a saturated ferrocene solution is injected into xylol. Due to the iron in the ferrocene as a catalyst particle, the CNTs can grow on the metallic surface, either in a tip growth mode (thus with the incorporation of the catalytic iron particle) or in a base growth mode (thus while leaving the catalytic iron particle behind on the substrate surface). In which mode the CNTs ultimately grow depends on the interaction of the substrate surface with the catalyst particle.

The CNT growth is determined by the interaction between the catalyst particle and the substrate. Weak bonds between the catalyst and the substrate lead to tip growth mode, strong bonds lead to the base growth mode.

The preferred length of the CNTs is thereby between 2 to 10 and 50 μm.

All types of metals can be used as electrically conductive substrates; the best results were likewise achieved with semiconductive wafers, for example on silicon wafers. The direct growth of CNTs on metal alloys—steel etc., high melting point alloys such as molybdenum or tungsten—is preferred.

In the direct deposition on metals, deposition mostly takes place in base growth mode. The CNTs grow slightly differently on the silicon wafers.

The CNT forests deposited on silicon often have the tip growth (and therefore the catalyst particle) at the tip of the tubes. Due to the uniform and reproducible growth, these layers can be subject to a flip transfer in adhesion promoter layers or conductive adhesive layers.

In the event that catalyst particles have been drawn along in the CNT growth, these can be separated via chemical etching with (for example) 40% saltpeter solution.

### Flip Transfer Process

Low-viscosity conductive adhesive materials as they are used in electronics are best suited to the flip transfer process. Solvent-containing and solvent-free materials or, respectively, conductive inks (from the Epo-Tek E3080 series (solvent-free), among others) can be used as conductive adhesive materials, or solvent-free systems such as the conductive adhesive Protavic can be used as well.

In particular, the materials should be temperature-stable.

For example, the curing of the conductive adhesives takes place in the range of room temperature to 400° C. Solvent-free adhesives are preferably used. This in particular because the reaction decrease response can then be ignored.

### Process:

The transfer of the CNT forest decisively depends on the fact that the aligned CNTs are not flooded by the adhesive or buckled by the adhesive mass in the transfer process. The CNT should have a length of 10 μm to 50 μm. The conductive adhesive system advantageously does not cover the sensitive CNT film during the contacting. Approximately 30%-70% of the CNT should remain outside. The viscosity of the conductive adhesive is advantageously in the range from 500 to 1000 mPas or between 100 and 2000 mPas. The thinner the viscosity of the conductive adhesive the better; however, a high electrical conductivity<0.001 Ohm per cm should also be achieved.

After the application and uniform wetting of the CNT tube base with the conductive adhesive, the sample is rotated by 180° and placed at a defined distance (distance>CNT length) above the metal substrate. The conductive adhesive thereby drains off the CNT walls and migrates onto the metal. The conductive adhesive thus establishes the connection of the CNT peaks to the metal substrate without mechanically loading the filigree CNTs.

The fixing can also take place via typical adhesion promoters. Curing of the conductive adhesives takes place at temperatures from room temperature to 400° C. Solvent-free adhesives are preferred since they have only a low reaction loss.

Good bonding to the conductive substrate, a good conductivity to the carbon nanotubes and a stable mechanical embedding of the aligned CNT tubes is obtained via the conductive adhesive in which the carbon nanotubes (CNTs) are embedded.

After the curing the first substrate on which the CNTs are grown can easily be removed; the bonding between (for example) the silicon and the CNT is low.

Alternatively, the aligned CNT layers can be directly submerged and mechanically anchored in a conductive adhesive layer that is applied on the metal via the flip technique described above. The removal process is similar.

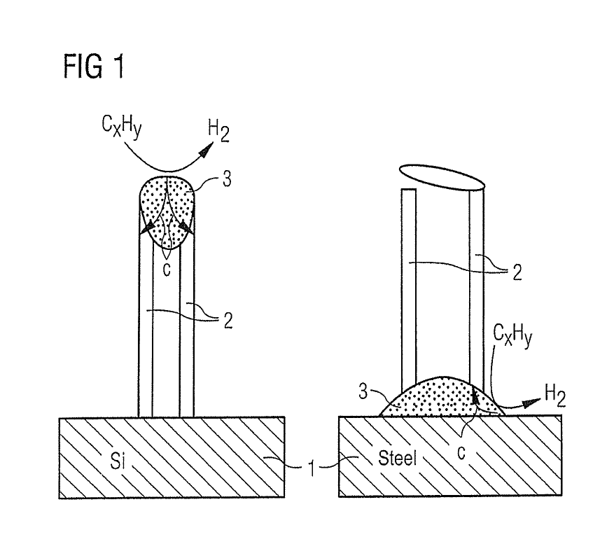

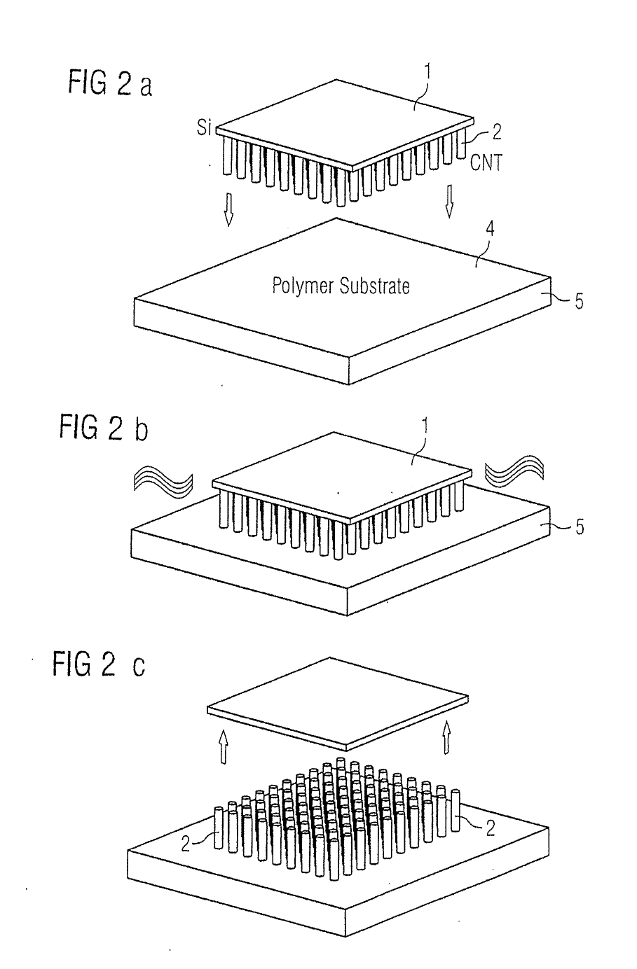

The production of a substrate according to one embodiment of the invention is explained in detail in the following using FIGS. 1 and 2a-2c.

FIG. 1 shows the difference as to whether the CNTs are deposited in tip growth or base growth mode.

FIG. 1, left side shows the deposition in the tip growth mode. The substrate 1 is visible; shown above this are, for example, two aligned, grown CNTs 2 connected at the top by the catalyst part 3 at their end removed from the carrier or substrate. Since the catalyst particle located on top of the nanotubes could contain iron as a catalyst, iron-containing metallo-organic compounds in this case tend to have the catalyst located on top of the nanotubes upon growth, for example.

FIG. 1, right side, shows the deposition in the base growth mode, wherein the catalyst particle 3 remains situated below on the substrate 1 while the CNTs 2 grow upward. Metallo-organic compounds with cobalt show this property of the catalyst, for example.

CNTs that are deposited in tip growth mode show that a catalyst particle 3 rests on the peak at each CNT tube 2. Open CNTs are obtained by transferring the CNT forest and submerging the CNTs—with the catalyst particle 3 far forward—in an adhesive layer.

This is explained in FIGS. 2a through 2c. How CNTs deposited in tip growth are transferred (flip transfer) is shown. FIG. 2a shows how the tip-grown CNTs are submerged with the underside (thus the first substrate 1) facing upward in a substrate 5 with conductive adhesive 4. As was already mentioned, the submersion depth of the CNTs is for example 50% of their length. Other values are also conceivable depending on substrate 1 and conductive adhesive 4.

As shown in FIG. 2b, the CNTs are then anchored in the conductive adhesive 4 by curing the conductive adhesive 4, such that the mechanical stability is attained.

As shown in FIG. 2c, a CNT forest open at the top is formed by removing the substrate 1.

The removal of the substrate can take place via etching, for example. It is thereby in particular advantageous if the peaks of the nanotubes are also equally sharpened with the etching so that nanotubes that optimally taper to a point and stand upright on the carrier are obtained. The etching can take place chemically or physically.

It is particularly advantageous for the etchant to be selected so that the conductive adhesive (thus also the conductive particles in the conductive adhesive, for example) is not attacked by the etchant.

In the event that a chemical removal of the first carrier occurs, a functionalization or derivatization of the carbon nanotube ends can be conducted at the same time.

A substrate for field emitters that uses CNTs aligned and grown essentially perpendicular on a conductive substrate can be achieved for the first time via the invention.

Via the invention the use of such a substrate for field emitters is disclosed for the first time. The invention also concerns a method to transfer a CNT forest from a first substrate to a second substrate coated with adhesive.

Alternatively, CNTs grown directly on the metal are mechanically stabilized by conductive adhesive. The peaks can also be correspondingly etched or shortened after the curing of the conductive adhesive.

Catalyst particles that are entrained in the CNT growth can be released by chemical etching in 50% HNO3.

Although modifications and changes may be suggested by those skilled in the art, it is the intention of the inventor to embody within the patent warranted hereon all changes and modifications as reasonably and properly come within the scope of his contribution to the art.

I claim as my invention:

1. A method for transferring carbon nanotubes from a first substrate to a second substrate, comprising the steps of:
growing carbon nanotubes on the first substrate with said carbon nanotubes aligned with each other and grown substantially perpendicularly to said first substrate, said carbon nanotubes on said first substrate each having a peak;
coating a second substrate with an uncured adhesive layer; and
transferring the carbon nanotubes from said first substrate to said second substrate by submerging the peaks of the carbon nanotubes in the uncured adhesive layer on the second substrate and anchoring the carbon nanotubes at said peaks in said adhesive layer by curing the adhesive layer and, after curing of said adhesive layer, removing said carbon nanotubes from said first substrate with said carbon nanotubes remaining anchored in the cured adhesive layer on said second substrate.

2. A method as claimed in claim 1 comprising covering only said peaks of said carbon nanotubes with said uncured adhesive layer on said second substrate.

3. A method as claimed in claim 1 comprising submerging said peaks of said carbon nanotubes in said uncured adhesive layer with 30% to 70% of a length of each nanotube remaining outside of said uncured adhesive layer.

4. A method as claimed in claim 1 comprising employing an adhesive having a viscosity when uncured in a range between 500 and 100 mPas.
